(19) United States
(12) Patent Application Publication
(10) Pub. No.: US 2008/0292122 A1
(43) Pub. Date: Nov. 27, 2008

(54) HEARING AID AND METHOD OF COMPENSATION FOR DIRECT SOUND IN HEARING AIDS

(75) Inventors: Morten Agerbaek Nordahn, Bronshoj (DK); David Morris, Malmo (SE)

Correspondence Address: SUGHRUE MION, PLLC, 2100 PENNSYLVANIA AVENUE, N.W., SUITE 800, WASHINGTON, DC, 20037, US

(73) Assignee: Widex A/S, Varlose (DK)

(21) Appl. No.: 12/185,902

(22) Filed: Aug. 5, 2008

Related U.S. Application Data
(63) Continuation-in-part of application No. PCT/EP2007/051891, filed on Feb. 28, 2007.
(60) Provisional application No. 60/778,377, filed on Mar. 3, 2006.

(51) Int. Cl. H04R 25/00

(52) U.S. Cl. 381/321

(57) ABSTRACT

A hearing aid comprises at least one microphone, a signal processing means and an output transducer, the signal processing means being adaptive to receive an input signal from the microphone, wherein the signal processing means is adapted to apply a hearing aid gain to the input signal to produce an output signal to be output by the output transducer, and wherein the signal processing means further comprises means for adjusting the hearing aid gain if the hearing aid gain would be below a direct transmission gain calculated for the hearing aid.

### BACKGROUND OF THE INVENTION

1. Field of the Invention

The present invention relates to the filed of hearing aids and more specifically to hearing aids utilizing compensation for direct sound. The invention, more particularly relates to hearing aids having means for adjusting the hearing aid gain if the hearing aid gain would be below a direct transmission gain and, still more particularly, respective systems and methods thereof. In addition the invention relates to a system compensating direct sound in a hearing aid.

2. Description of the Related Art

It is a widely known problem in hearing aid design that a hearing aid gain is often applied without taking the acoustic effect of the ventilation canal and/or a leakage path between the earplug of the hearing aid and the ear canal into account.

In hearing aids with open fittings or large ventilation canals, sound may enter directly through the vent and adds to the amplified sound through the hearing aid. In case these two sound signals are of similar amplitude, the summed signal may at certain frequencies be infinitely small if the relative phase between the signals is 180°. Such a phase disrupted signal has an unnatural rasping sound and, for example, speech intelligibility may suffer as a consequence. The degree to which this is a problem depends on the individual hearing loss and earplug, and is normally disregarded in hearing aid fitting. Therefore, acoustic effects of the ventilation canal and possible leakage paths between the hearing aid and the ear canal are still challenges in today's hearing aid design.

Thus, there is a need for improved hearing aids as well as improved techniques for utilizing direct sound compensation in hearing aids.

### SUMMARY OF THE INVENTION It is therefore an object of the present invention to provide hearing aids and methods of processing signals in a hearing aid taking in particular the mentioned requirements and drawbacks of the prior art into account.

It is in particular an object of the present invention to provide a hearing aid and a respective method providing an compensation for the amount of directly transmitted sound through the vent into account.

According to a first aspect of the present invention, there is provided a hearing aid comprising at least one microphone, a signal processing means and an output transducer, the signal processing means being adaptive to receive an input signal from the microphone, wherein the signal processing means is adapted to apply a hearing aid gain to the input signal to produce an output signal to be output by the output transducer, and wherein the signal processing means further comprises means for adjusting the hearing aid gain if the hearing aid gain would be below a direct transmission gain calculated for the hearing aid.

The provided hearing aid with the mean for adjusting the hearing aid gain by a direct transmission gain gives a knowledge about the amount of directly transmitted sound and provides information about how much a certain frequency band may be attenuated before the direct sound becomes dominant over the amplified sound.

According to another aspect of the present invention, there is provided a hearing aid that is capable to avoid phase disruption in the output signal by taking the direct transmitted sound into account when calculating the hearing aid gain to produce the output signal.

According to another aspect of the present invention, there is provided a method of compensating direct transmitted sound in a hearing aid which comprises the steps of estimating an effective vent parameter for the hearing aid, calculating a direct transmission gain based on the effective vent parameter, applying a hearing aid gain to produce an output signal from an input signal wherein the direct transmission gain is used as a lower gain limit below which the hearing aid gain is not set.

According to still another aspect of the present invention, there is provided a method of determining direct transmitted sound in a hearing aid which comprises the steps of estimating an effective vent parameter for the hearing aid, and calculating a direct transmission gain based on the effective vent parameter.

The provided methods enable to calculated the direct transmission gain once when fitting the haring aid which may then be used according to further methods and systems according to the present invention for the dynamic correction of also other hearing aid parameters than gain.

It may be seen as a true advantage that the hearing aids, systems and methods according to the present invention provide the ability to adjust the hearing aid gain to compensate for the interaction of directly transmitted sound and the sound amplified by the hearing aid gain in real time.

Which means that according to an embodiment of the present invention the hearing aid is able to dynamically adjust the hearing aid gain in each frequency band based on the instantaneous gain level. That is, a new approach according to which the direct transmission gain is taken into account in the noise reduction technique, given the user a better speech intelligibility in noise is proposed herewith.

The invention, according to further aspects, provides a system of reducing noise in a hearing aid, a computer program and a computer program product as recited in claims 34, 35 and 36.

Further specific variations of the invention are defined by the further claims.

Other aspects and advantages of the present invention will become more apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIGS. 1a-c depict a schematic block diagrams of a hearing aid according to the present invention.

FIG. 2 depicts two frequency dependent signals with a relative phase are added here, to clarify the principle of adding two sound signals at the eardrum. The black dotted lines are the magnitude of the two signals. The grey dash-dotted lines represents the sum of these signals, when the two signals are in phase for all frequencies (upper curve), and when they are out of phase for all frequencies (lower curve), respectively. The full fat line shows what happens, if the phase difference varies linearly with frequency.

FIG. 3 depicts the difference in dB between the amplitude of the in-phase summed signal and the out-of-phase summed signal as a function of the difference between the amplitude of the two signals

FIG. 4 depicts a flow diagram of a method according to an embodiment of the present invention.

FIG. 5 depicts a flow diagram of a method according to another embodiment of the present invention.

FIG. 6 depicts a flow diagram of a method according to another embodiment of the present invention.

FIG. 7 shows in diagrams the hearing aid gain and the damping function in an example of the damping of the applied hearing aid gain in the case where the hearing aid gain becomes smaller than the minimal amplification limit according to an embodiment of the present invention.

FIG. 8 shows the damping function for different compression factors according to an embodiment of the present invention.

FIG. 9 shows in a diagram the hearing aid gain when it is restricted downward by the DTG+k according to an embodiment of the present invention.

### DESCRIPTION OF EMBODIMENTS OF THE INVENTION

When describing the invention according to embodiments thereof, terms will be used which are described as follows.

Compressor: a device commonly utilized in modern hearing aids which operate to compress the dynamic range of the input signals. Useful for treatment of presbyscusis (loss of dynamic range due to haircell-loss). Actually, compressing hearing aids often apply expansion for low level signals, in order to suppress microphone noise. Often also used as a soft-limiter in order to limit maximum output level at safe or comfortable levels. The compressor has a non-linear gain characteristic and, thus, is capable of providing less gain at higher input levels and more gain at lower input levels. Hearing aids embodying a compressor as signal processor are often referred to as non-linear gain or compressing hearing aid.

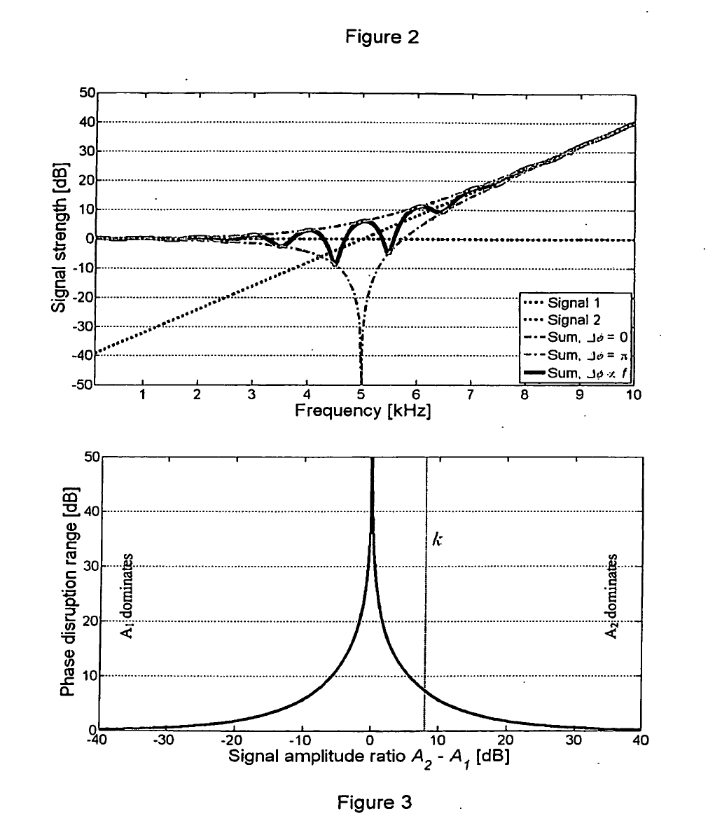

Phase disruption: The sound level at the eardrum of the user is a superposition of the unaided direct sound and the amplified sound from the hearing aid. The interference of the two sound sources may lead to fluctuations in the sound input at frequencies where the unaided direct sound and the amplified sound from the hearing aid has about the same magnitude but has opposite phase. This general phenomenon is illustrated in FIG. 2, which illustrates the addition of two signals with differing magnitude and phase.

At a certain frequency, the sum of two harmonic signals can be written as

A₁cos(2πft+φ)+A₂cos(2πft+φ₂) (1)

In our example, A1=1, φ1=0 and A2∝f. φ2 is either 0, π or ∝ f. With simple calculations, both constructive and destructive interference can be made clear, whereas the sum of two signals which frequency dependent phase and amplitude is more complex to describe analytically. In this case, the resulting phase disruption will depend on the amplitudes and phases of the signals. However, since constructive and destructive interference constitutes the upper and lower limit of the phase disruption, respectively, we know, that a phase disrupted signal lies somewhere in between these lines, as shown in FIG. 2 for the case φ2 ∝ f. Note that the ratio of the absolute amplitude corresponds to the difference of the amplitudes in dB, since dB in calculated as 20log10(A). An amplitude of 0 thus corresponds to −∞ dB.

The lower dash-dotted grey line shows that in case the two signals are out of phase with the exact same amplitude, the total signal cancels out and becomes infinitely small. This is called destructive interference or phase cancellation. On the other hand, if the two signals are in phase at all frequencies, the amplitudes simply add up in a constructive interference, and gives 6 dB more sound pressure at the frequency where the two signals have the same amplitude, which can be seen in the upper dash-dotted grey line at 5 kHz. These two cases, however, are rarely met with respect to the hearing aid sound and the direct sound, since both have a varying frequency dependent phase. The black line therefore exemplifies how the total sound pressure might look like, if the relative phase depends linearly on frequency. Note, that at some frequencies, constructive interference increases the magnitude of the total signal, whereas for other frequencies, destructive interference diminishes the total signal. Since the signals do not cancel out as such at frequencies where the relative phase is almost π and the relative amplitude is not quite 1, this phenomenon is called phase disruption.

The above example is general, and can be extrapolated to the situation in a users ear, where the amplified sound and the direct sound superpose. This in turn means that the amplified sound has to exceed a certain level before the total sound pressure at the eardrum remains unperturbed by the direct sound with respect to phase disruption. Maintaining the hearing aid gain at a similar magnitude to the direct sound would result in an increased risk of phase disruption, which is avoided with the current invention.

As is observed in FIG. 2, the difference in amplitude between the amplified sound and the unaided direct sound must be higher than a certain amount (a safety margin) to minimize phase disruption. This amount corresponds to the minimum amplification or the directly transmitted gain+k in the first figure. The safety margin is the factor k, which in principle could be set to anything. If k is large and negative, the interaction between direct and amplified sound is neglected and nothing extraordinary is ever done to take the interaction into account. If k is large and positive, measures are taken all the time, which is also not optimal. Choosing the factor k is therefore a trade-off between minimizing the risk of phase disruption and limiting the dynamic range of the hearing aid gain.

FIG. 3 shows the difference in dB between the amplitude of the in-phase summed signal and the out-of-phase summed signal as a function of the difference between the amplitude of the two signals. The curve thus shows the uncertainty or possible spread of the total sound pressure due to phase disruption, meaning, that if one signal is 10 dB larger than the other, the phase disruption may in a worst case scenario cause the amplitude of the summed signal to vary up to −5 dB from the in-phase summed signal. Values from 0 and upward is applicable, better between 5 and 15 dB. Of course, a value of 0 dB would incur a high risk of phase disruption. A value of k=8 gives a phase disruption range of about +−3 dB, which may be considered acceptable.

Extracting the general phase disruption graphs in the example as illustrated in FIG. 2 to the situation in the hearing aid 200, the signal amplitude in FIG. 3 is the difference between the hearing aid sound and the directly transmitted sound in each band, i.e. HA-DTG (Direct Transmitted Gain) in dB, i.e. A₁ is DTG and A₂ is HA. Note, that the DTG is fixed once the earplug is made, whereas the hearing aid gain may change with the sound input. The hearing aid sound is thus the only variable, once the vent is chosen. If the hearing aid was turned off, the sound from the hearing aid would be −∞ (completely silent), obviously meaning that the DTG would dominate totally. This would correspond to −∞ on the x-axis in FIG. 3, which gives no phase disruption problems, as we would expect. On the contrary, if the hearing aid gain was e.g. 60 dB, the direct sound is negligible in comparison, and no phase disruption is risked. It is only when the sound level of the direct sound and the hearing aid sound is comparable (A₂≈A₁), that the strength of the summed signal may vary significantly as indicated in FIG. 3.

Thus, in the current invention, the factor k, which is indicated as an example in FIG. 3, constitutes a lower limit, below which the hearing aid gain cannot be set during the optimization process, without risking a large amount of phase disruption.

According to embodiments, below this limit actions are taken with regards to either turning off that particular band during fitting (stationary compensation) or dynamically reducing the hearing aid gain in case the limit is surpassed.

Unpublished PCT application PCT/EP2005/055305 titled “Method and system for fitting a hearing aid”, which is herewith incorporated by reference and assigned to the same applicant, provides a method for estimating otherwise unknown functions such as the vent effect and the direct transmission gain for an in-situ hearing aid. The thereby given estimate of the direct transmission gain presents the amplification of sound from the outside of the vent to the eardrum. These functions were used for correcting the in-situ audiogram, the hearing aid gain as well as the direct transmission gain by the vent effect. The present invention patent now provides utilization of the calculated direct transmission gain for the correction of other hearing aid parameters than gain.

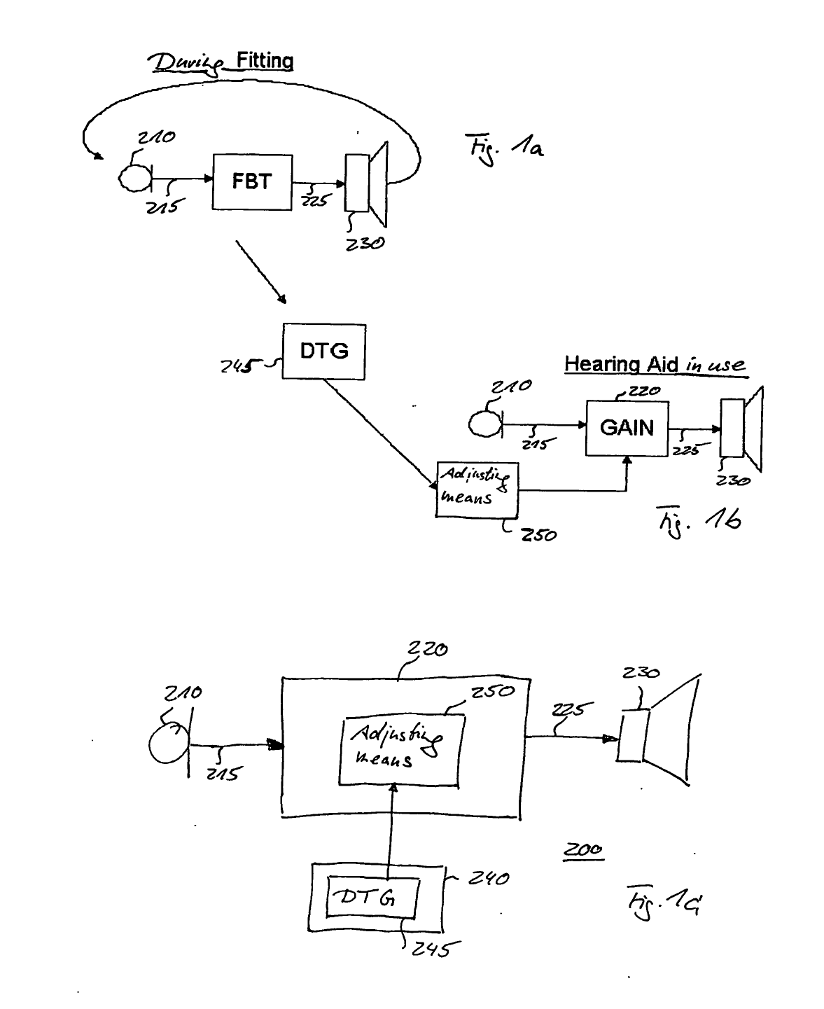

Reference is now made to FIGS. 1a-c, which shows a hearing aid 200 according to the first embodiment of the present invention.

The hearing aid comprises an input transducer or microphone 210 transforming an acoustic input signal into an electrical input signal 215, an A/D-converter (not shown) for sampling and digitizing the analogue electrical signal. The so processed electrical input signal is then feed into signal processing means like a compressor 220 generating an electrical output signal 225 by applying a compressor gain in order to produce an output signal that is hearing loss compensated to the user requirements. The compressor gain characteristic is, according to an embodiment, non-linear to provide more gain at low input signal levels and less gain at high signal levels. The signal path further comprises an output transducer 230 like a loudspeaker or receiver transforming the electrical output signal into an acoustic output signal.

The signal processing means further comprises an adjusting means 250 for adjusting said hearing aid gain if the hearing aid gain would be below the direct transmission gain (DTG) calculated for the hearing aid.

The calculation of the DTG is done by performing a feedback test (FBT) as schematically illustrated in FIG. 1a. Then, the in-situ vent effect is estimated and the DTG is calculated from the vent effect. Document PCT/EP2005/055305 describes this in detail.

According to an embodiment as illustrated in FIG. 1c, the DTG 245 calculated for the hearing aid as a set of frequency dependent gain values is then stored in memory 240 of the hearing aid. The DTG is then used by the adjusting means 250 to adjust the hearing aid gain in order to compensate for possible phase disruption or any other artefacts in the combined acoustic signal on the hear drum resulting from the gained output signal and the direct transmitted sound.

In the case where at the eardrum the direct sound is similar in strength to the sound amplified by the hearing aid, the direct sound is actually adequate for the hearing aid user to hear the sound. Therefore, according to an embodiment, the means for adjusting the hearing aid gain or a respective method step simply turn off the band which gives rise to phase disruption. In open fittings, this is in particular relevant in the lowest bands, where most of the amplified sound is damped due to the open ear. According to an embodiment, a hearing aid with an open earplug preventing occlusion has the 3 lowest bands of 15 consequently turned off, whereas the 4 next bands can be disabled or not by the adjusting means depending on the instantaneous hearing aid gain in these bands.

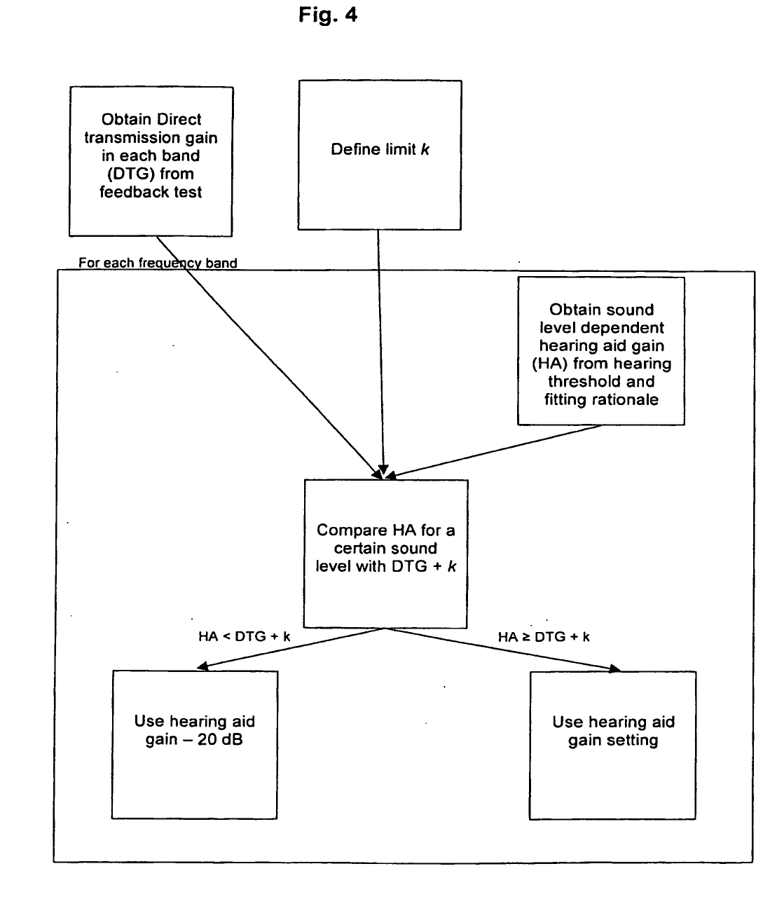

According to the present invention, the compensation can either be static or dynamic. In FIG. 4, a flow chart for a static compensation according to an embodiment is shown. In the static case, the decision whether the particular bands should be turned off is taken once during fitting, based on the gain setting of the hearing aid. The amplified sound in each band needs to be more than k dB higher than the direct sound in order to avoid phase disruption problems (explained in the other documents). Since we know both the gain and the direct sound, it is possible to determine when a band is unnecessary or not. However, the gain in non-linear hearing aids depends on the input sound level, which means that the actual gain fluctuates with the input signal. That means that even though the vent has a permanent structure, the phase disruption problem may be present for e.g. loud sounds (where the gain is low) but not for soft sounds(where the gain is high). This means that the amplified sound level may be close to the level of the direct sound for loud sounds, but well above for soft sounds. In the static case, the band should therefore be disabled based on the gain for soft sounds, since then run the risk of disabling bands that may otherwise be useful to amplification.

According to an embodiment, dynamic compensation is provided which takes the actual time dependent gain of the hearing aid into account and compares this to the direct sound, which was estimated during fitting. In the dynamic case, bands are not disabled at the fitting when phase disruption problems within a given band are deemed likely. Instead, when the hearing aid gain is less than the limit (K dB), the gain is overlayed with a time dependent gradually increasing damping. This could change the actual gain by a factor of e.g. down to −20 dB, until the hearing aid gain would become higher than the limit again. The actual gain is then the sum of the damping function and the hearing aid gain. At this point the damping will gradually return to zero. In this way, the hearing aid can automatically determine when the amplified sound becomes problematic during use, and successively account for this without perceptibly jeopardizing the sound quality.

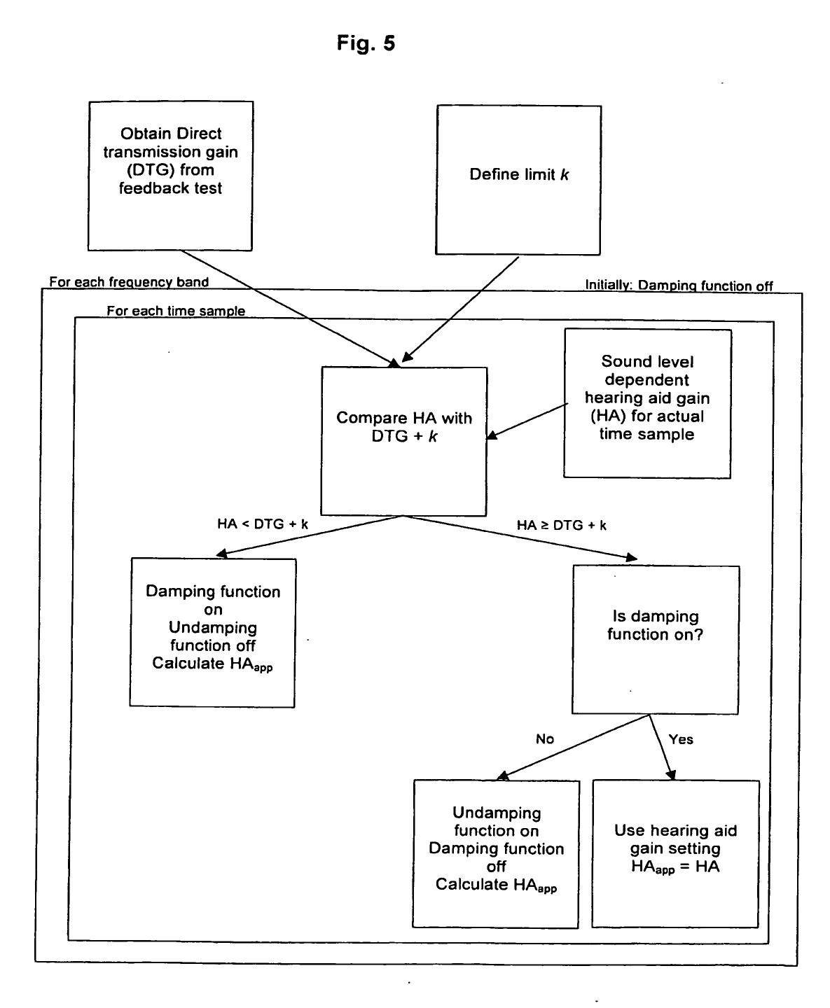

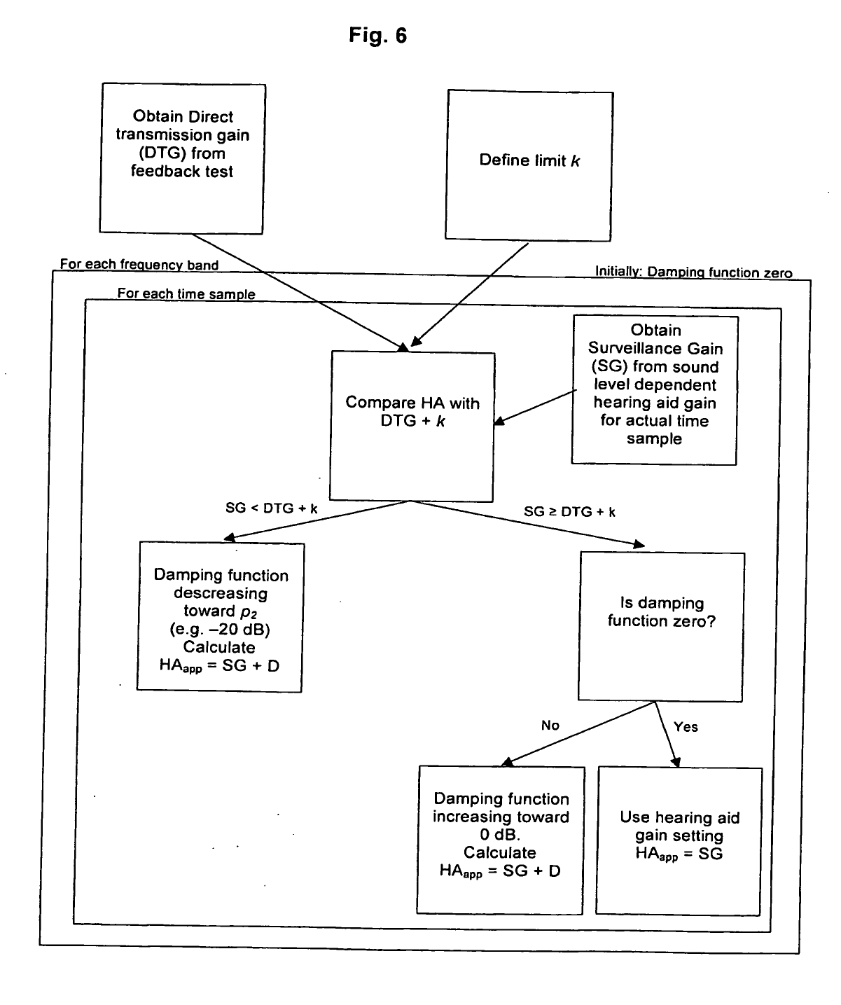

In FIGS. 5 and 6, flow charts for a static compensation according to embodiments are shown.

For example, in the case where the hearing threshold is low and the vent is large, as is often the case for high frequency hearing losses, the sound level of sound passing through the vented earplug may be in the same order as the sound generated by the hearing aid. However, since the hearing aid gain changes with the sound level, there may be some listening situations where the total sound signal at the eardrum is distorted by phase disruptions, whereas other listening situations may give a good sound quality because the hearing aid gain is well above or below the direct sound. For example, the hearing aid of a person at a crowded cafe will give a low gain due to the compression of the hearing aid. In the low bands, the hearing aid gain may be 0 dB. The directly transmitted sound may also be 0 dB in the low bands due to a large vent. In this case, the person may perceive a distorted sound due to phase disruptions. The same person may then go outside in a park and listen to birds and other people talking from afar. The hearing aid gain in the situation will be larger, and may thus be maybe 10 dB, which is high enough for the hearing aid sound to dominate the total sound at the eardrum, thus diminishing the risk of phase disruption and giving a better sound quality. In order to cope with this problem, there is provided a dynamic compensation according to the present invention as described in the following

With reference to FIG. 6, the Surveillance Gain is the gain calculated in the hearing aid by use of the hearing threshold and the fitting rationale. This gain, which without compensation for the direct sound would be the applied hearing aid gain, is time sample by time sample compared to the minimal amplification limit, which is the direct sound plus a safety margin, i.e. DTG+k. The applied hearing aid gain (HAₛₚₚ) is the gain given through the loudspeaker of the hearing aid. The applied hearing aid gain differs from the SG by the damping function D, such that HAₐₚₚ=SG+D. If the surveillance gain is lower than DTG+k, the damping function is activated. The damping function may be defined in many ways, one of which may be

$$D = \{ \begin{matrix}{p}_{1} & for t < {t}_{0} \\ f ( t ) & for {t}_{0} \leq t \leq Δ T + {t}_{0} \\ {p}_{2} & for t > Δ T + {t}_{0}\end{matrix} \qquad ( 2 )$$

This function, beginning at time t₀, describes a gradual transition between two values of the damping function, p₁ and p₂. The value ΔT is the total duration of the damping signal, i.e. the time for the damping to complete. By choosing ΔT very small, the applied hearing aid gain is rapidly dampened, so the hearing aid sound is rapidly turned off. The damping may be based on the criterion SG<DTG+k.

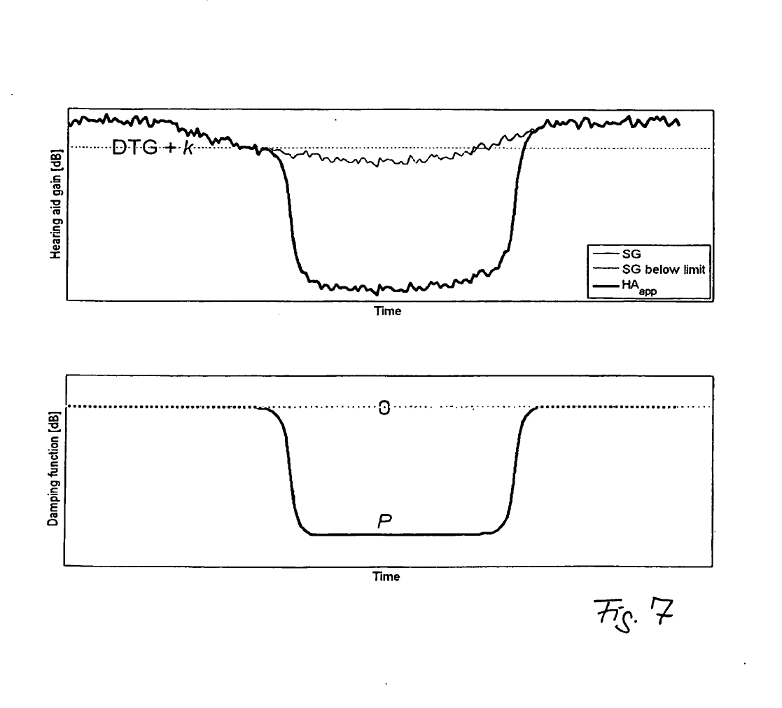

As soon as this criterion is fulfilled, the applied gain begins to fall from p₁=0 dB toward the maximum numerical value of the damping P, which may be set at −20 dB as indicated in FIG. 7. The maximum numerical value of the damping P must be chosen small enough for the applied gain to generate a sound level at the eardrum, which is insignificant with regards to the direct sound, such that the risk for phase disruption is inconsequential. When the criterion is no longer met before the damping has reached equilibrium a new cycle is commenced, where p₁ is now the actual value of the damping function at the particular time the criterion state was changed, and p₂=0 dB. As soon as the criterion SG<DTG+k is not fulfilled anymore, the applied gain begins to rise again toward the surveillance gain, SG. This means that every time the criterion is met, the damping function dampens the applied hearing aid gain towards e.g. −20 dB during ΔT s. Every time the criterion is not met, the damping function will seek to rise to 0 dB.

An example of f(t) may be

$$f ( t ) = \frac{{p}_{2} - {p}_{1}}{2} \frac{Arc tan c ( t - Δ T / 2 )}{Arc tan c Δ T / 2} + \frac{{p}_{2} - {p}_{1}}{2} \qquad ( 3 )$$

The compression factor c controls how abruptly the transition should occur. With a high c, the transition occurs abruptly at ΔT/2, whereas a very low c makes an almost linear transition between p₁ and p₂. Note that there is a time delay since the damping function needs time to have an effect. FIG. 7 further shows an example of the dynamical compensation for direct sound where ΔT=1 s and c=10 s⁻¹.

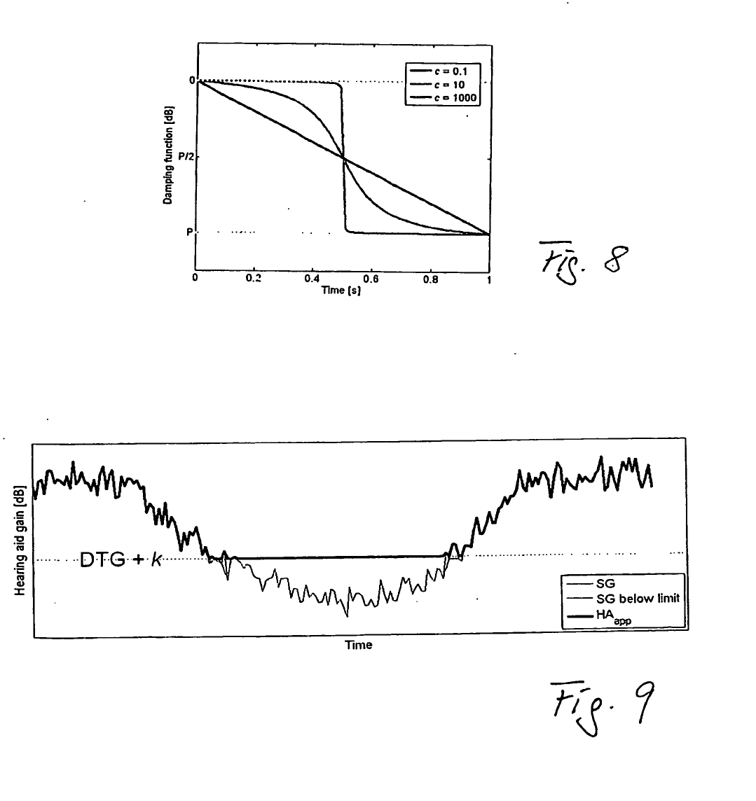

In FIG. 8 the damping function is shown for different compression factors, when at time t=t₀ the SG becomes smaller than the minimal amplification limit, and stays below for over 1 second.

According to another embodiment of the present invention, a hearing aid gain is provided that is restricted by the minimal amplification as illustrated in FIG. 9. According to this embodiment, it is provided to compensate for the DTG by never letting the hearing aid gain get lower than HA=DTG+k. This means that the original gain is modified with a damping function, which always generates an applied gain that is DTG+k or above. This method may be used either on its own, but also in conjunction with a static compensation, such that some bands may be turned off, whereas other bands may be ruled by the dynamic compensation by restricting the gain to a minimal value of DTG+k. When the damping function is added to the grey part of the hearing aid gain, the flat line results as shown in FIG. 9.

According to embodiments of the present invention, systems and hearing aids described herein may be implemented on signal processing devices suitable for the same, such as, e.g., digital signal processors, analogue/digital signal processing systems including field programmable gate arrays (FPGA), standard processors, or application specific signal processors (ASSP or ASIC). Obviously; it is preferred that the whole system is implemented in a single digital component even though some parts could be implemented in other ways—all known to the skilled person.

Hearing aids, methods, systems and other devices according to embodiments of the present invention may be implemented in any suitable digital signal processing system. The hearing aids, methods and devices may also be used by, e.g., the audiologist in a fitting session. Methods according to the present invention may also. be implemented in a computer program containing executable program code executing methods according to embodiments described herein. If a client-server-environment is used, an embodiment of the present invention comprises a remote server computer which embodies a system according to the present invention and hosts the computer program executing methods according to the present invention. According to another embodiment, a computer program product like a computer readable storage medium, for example, a floppy disk, a memory stick, a CD-ROM, a DVD, a flash memory, or any other suitable storage medium, is provided for storing the computer program according to the present invention.

According to a further embodiment, the program code may be stored in a memory of a digital hearing device or a computer memory and executed by the hearing aid device itself or a processing unit like a CPU thereof or by any other suitable processor or a computer executing a method according to the described embodiments.

Having described and illustrated the principles of the present invention in embodiments thereof, it should be apparent to those skilled in the art that the present invention may be modified in arrangement and detail without departing from such principles. Changes and modifications within the scope of the present invention may be made without departing from the spirit thereof, and the present invention includes all such changes and modifications.

What is claimed is:

1. A hearing aid comprising at least one microphone, a signal processing means and an output transducer, said signal processing means being adaptive to receive an input signal from the microphone, wherein said signal processing means is adapted to apply a hearing aid gain to said input signal to produce an output signal to be output by said output transducer, and wherein said signal processing means further comprises means for adjusting said hearing aid gain if said hearing aid gain would be below a direct transmission gain calculated for the hearing aid.

2. The hearing aid according to claim 1 or 2, wherein said means for adjusting said hearing aid gain provides a safety margin k and is adapted to adjust said hearing aid gain if said hearing aid gain would be below said direct transmission gain plus said safety margin k.

3. The hearing aid according to claim 2, wherein said safety margin k is a gain value in the range of 0 to 15 dB.

4. The hearing aid according to claim 2, wherein said safety margin k is a gain value of about 8 dB.

5. The hearing aid according to one of the preceding claims, wherein said means for adjusting said hearing aid gain and is adapted to adjust said hearing aid gain by a damping of said hearing aid gain.

6. The hearing aid according to one of the preceding claims, wherein said hearing aid further comprises a memory being adapted to store said direct transmission gain calculated for said hearing aid and its user, and to provide a sound level dependent hearing aid gain, and wherein said means for adjusting said hearing aid gain being adapted to apply said sound level dependent hearing aid gain to said input signal to produce a hearing aid gain amplified output signal, wherein said hearing aid gain is adjusted if said hearing aid gain is equal or lower than said direct transmission gain.

7. The hearing aid according to claim 6, wherein said signal processing means further comprising a comparator being adapted to compare said hearing gain with said direct transmission gain plus said safety margin k, and, if said hearing aid gain is smaller than said direct transmission gain plus said safety margin k, said means for adjusting said hearing aid gain is adapted to lower said hearing aid gain by a factor F and to use said lowered hearing aid gain to produce said amplified output signal, and, if said hearing aid gain is equal or larger than said direct transmission gain plus said safety margin k, said means for adjusting said hearing aid gain is adapted to use said hearing aid gain to produce said amplified output signal.

8. The hearing aid according to claim 6 or 7, wherein said sound level dependent hearing aid gain comprises a set of frequency and input signal level dependent gain values obtained from hearing threshold and fitting rational.

9. The hearing aid according to claim 6, wherein said signal processing means is further adapted to obtain an actual time sample of said input signal, and to calculate a surveillance gain from said sound level hearing aid gain for said actual time sample, said hearing aid further comprises a comparator being adapted to compare said surveillance gain with said direct transmission gain plus said safety margin k, and, if said surveillance gain is smaller than said direct transmission gain plus said safety margin k, said means for adjusting said hearing aid gain is adapted to decrease a damping function toward a factor F, and, if said surveillance gain is equal or larger than said direct transmission gain plus said safety margin k, said means for adjusting said hearing aid gain is adapted to increase said damping function toward 0 dB, and said means for adjusting said hearing aid gain is adapted then to calculate said hearing aid gain by adding said damping function to said surveillance gain, and to use said calculated hearing aid gain to produce said amplified output signal.

10. The hearing aid according to claim 9, wherein said surveillance gain comprises a set of frequency dependent gain values obtained from said sound level dependent hearing aid gain set at said actual time sample.

11. The hearing aid according to one of the preceding claims, wherein said means for adjusting said hearing aid gain is adapted not to set said hearing aid gain to a value below said direct transmission gain plus a safety margin k.

12. The hearing aid according to one of the preceding claims, further comprising a band-split filter for converting said input signal into band-split input signals of a plurality of frequency bands and wherein said hearing aid is further adapted to process said band-split input signals in each of said frequency bands independently.

13. The hearing aid according to claim 12, wherein said means for adjusting said hearing aid gain is adapted to apply said frequency dependent hearing aid gain only in some frequency bands whereas the other frequency bands are turned off.

14. The hearing aid according to claim 12, wherein said means for adjusting said hearing aid gain is adapted to enable or disable the application of said hearing aid gain in certain frequency bands based on said hearing aid gain in these frequency bands.

15. A method of compensating direct transmitted sound in a hearing aid, comprising:
estimating an effective vent parameter for said hearing aid;
calculating a direct transmission gain based on said effective vent parameter;
applying a hearing aid gain to produce an output signal from an input signal wherein said direct transmission gain is used as a threshold at which said hearing aid gain is adjusted to a value other then said direct transmission gain.

16. A method of determining direct transmitted sound in a hearing aid, comprising:
estimating an effective vent parameter for said hearing aid;
calculating a direct transmission gain based on said effective vent parameter.

17. The method according to claim 15 or 16, wherein said step of estimating said effective vent parameter comprises:
measuring a loop gain of an in-situ hearing aid;
estimating said effective vent parameter for said hearing aid by determining that vent parameter as said effective vent parameter that provides the best fit between a number of predetermined loop gains and the measured loop gain.

18. The method according to claim or, wherein said step of calculating said direct transmission gain comprises calculating a set of frequency dependent direct transmission gain values.

19. The method according to claim 17, wherein said loop gain is measured by a feedback test of said hearing aid.

20. The method according to claim 19, wherein said feedback test is performed during fitting of the hearing aid to the user.

21. The method according to one of claims 16 to 20, further comprising the step of obtaining a sound level dependent hearing aid gain comprising a set of frequency and input sound level dependent gain values from a hearing threshold level and a fitting rational.

22. A method of compensating direct sound in a hearing aid comprising at least one microphone producing an input signal, a signal processing means producing an output signal from said input signal, and an output transducer outputting said output signal, wherein said method comprises:
storing a direct transmission gain calculated for said hearing aid and its user in a memory of said hearing aid;
providing a sound level dependent hearing aid gain; and
applying said sound level dependent hearing aid gain to said input signal to produce a hearing aid gain amplified output signal, wherein said hearing aid gain is adjusted if said hearing aid gain is equal or lower than said direct transmission gain.

23. The method according to claim 22, wherein said method further comprises defining a safety margin k.

24. The method according to claim 23, wherein the safety margin is a value in the range between 0 and 15 dB.

25. The method according to claim 23, wherein the safety margin is a value of about 8 dB.

26. The method according to one of claims 22 to 25, wherein said step of adjusting said hearing aid gain comprises:
comparing said hearing gain with said direct transmission gain plus said safety margin k;
if said hearing aid gain is smaller than said direct transmission gain plus said safety margin k, lowering said hearing aid gain by a factor F and using said lowered hearing aid gain to produce said amplified output signal;
if said hearing aid gain is equal or larger than said direct transmission gain plus said safety margin k, using said hearing aid gain to produce said amplified output signal.

27. The method according to one of claims 22 to 25, further comprising:
obtaining an actual time sample of said input signal;
calculating a surveillance gain from said sound level hearing aid gain for said actual time sample;
comparing said surveillance gain with said direct transmission gain plus said safety margin k;
if said surveillance gain is smaller than said direct transmission gain plus said safety margin k, decreasing a damping function toward a factor F;
if said surveillance gain is equal or larger than said direct transmission gain plus said safety margin k, increasing said damping function toward 0 dB;
calculating said hearing aid gain by adding said damping function to said surveillance gain; and
using said calculated hearing aid gain to produce said amplified output signal.

28. The method according to claim 27, wherein said surveillance gain comprises a set of frequency dependent gain values obtained from said sound level dependent hearing aid gain set at said actual time sample.

29. The method according to one of claims 22 to 28, further comprising that said hearing aid gain is not allowed to be set to a value below said direct transmission gain plus a safety margin k.

30. The method according to one of claims 15 to 29, further comprising the step of converting said input signal into band-split input signals of a plurality of frequency bands and wherein said method is further carried out for each of said frequency bands.

31. The method according to claim 30, wherein said method is applied only in some frequency bands whereas the other frequency bands are turned off.

32. The method according to claim 30, wherein said method further comprises enabling or disabling of said method in certain frequency bands based on said hearing aid gain.

33. The method according to claim 30, wherein said further comprises enabling or disabling of said method in certain frequency bands based on said direct transmission gain.

34. A system for compensating direct sound in a hearing aid comprising means for carrying out a method according to one of claims 15 to 33.

35. A computer program comprising executable program code which, when executed on a computer, executes a method according to one of claims 15 to 33.

36. A computer program product containing a computer readable medium with executable program code which, when executed on a computer, executes a method according to one of claims 15 to 33.
